(19) United States
(12) Patent Application Publication
(10) Pub. No.: US 2008/0065295 A1
(43) Pub. Date: Mar. 13, 2008

(54) Acceleration Sensor In A Control Unit

(76) Inventors: Gernod Heilmann, Hemmingen (DE); Cord Plesse, Ludwigsburg (DE)

Correspondence Address: KENYON & KENYON LLP, ONE BROADWAY, NEW YORK, NY, 10004, US

(21) Appl. No.: 11/791,589

(22) PCT Filed: Sep. 9, 2005
(86) PCT No.: PCT/EP05/54494

§ 371 Date: Oct. 29, 2007

(30) Foreign Application Priority Data
Nov. 23, 2004 (DE) 10 2004 056 416.7

(51) Int. Cl. G06F 19/00

(52) U.S. Cl. 701/45

(57) ABSTRACT

An acceleration sensor in a control unit for activating occupant protection devices contains a logic component for transferring a signal characterizing an acceleration to a processor in the control unit. This logic component is used for checking the signal of the acceleration sensor, the output stages being enabled as a function of the check.

PCT International Patent Publication No. WO 02/42123 describes a control unit used for activating restraining means. A safety switch evaluates sensor values from internal and external sensors for their validity in order to then enable the output stages via time stages as a function of the validity check.

### BACKGROUND INFORMATION

### Summary Of The Invention

The acceleration sensor in a control unit according to the present invention has the advantage that the validity check of the sensor values is integrated in an acceleration sensor in the control unit. This application is advantageous in particular if no external sensors are used. Accordingly, the present invention is suitable for simple restraint systems having few trigger circuits that are in particular activated by a centrally located acceleration sensor. The acceleration sensor has a logic component for transmitting the sensor values to the processor which calculates the triggering algorithm in the control unit. In addition, this logic component is directly connected to the output stages. This is necessary in order to be able to enable or block the output stages as a function of this validity check. Despite the simpler design, a control unit including the acceleration sensor of the present invention has high reliability.

It is in particular advantageous that the logic component checks the acceleration signal for validity using a fixed threshold value. Because one or two accelerations are involved when measurements are taken in different directions, two fixed threshold values or even only one fixed threshold value may be used when sensing is performed solely in the direction of travel.

Furthermore, it is advantageous that the logic component is connected to the output stages in such a way that one line leads to the positive output stage and another line, independent of it, leads to the negative output stage. This makes it possible to enable the output stages differently and also to test them separately from one another.

It is a further advantage that the logic component enables the output stages for a predetermined time as a function of the check. This means that the logic component has timing elements such as a monoflop in order to carry out the enabling or blocking for predetermined periods of time. This prevents the output stages from being enabled for a long time in the event of enabling but instead only for a short time that must be adequate to be ready in the event of a triggering case.

Furthermore, it is advantageous that the acceleration sensor enables the output stages or at least one output stage as a function of a self-test. If the sensor detects the occurrence of an error in a self-test, this must result in an immediate block of at least one output stage. This provides the entire system with a high level of reliability.

In order to further simplify the monitoring of the control unit, a function or a plurality of functions is also integrated into the logic component for testing the processor. This means that the acceleration sensor itself tests the processor that evaluates the sensor data. In addition, a watchdog is used here, two watchdogs in particular, in order to test both the real-time level of the operating system of the processor and the background level. A watchdog timer having a short response time is used for the real-time level and one having a considerably longer response time is used for the background level. In this case, a watchdog is understood in such a way that the processor continuously operates the watchdog in order to verify the operability of the processor with respect to the program flow. This means that the processor must send the watchdog a signal at predetermined time intervals; should it fail to receive such a signal, the watchdog indicates a processor error. Also as a function of this test, the output stages are blocked or enabled via the two lines leading from the acceleration sensor to the positive and negative output stage.

Finally, it is also advantageous that the logic component is situated in a housing of the acceleration sensor, so that a structural unit is present. This makes the acceleration center including the logic component easy to handle and also easy to install in a control unit.

### BRIEF DESCRIPTION OF THE DRAWINGS

FIG. 1 shows a block diagram of a control unit.

FIG. 2 shows a block diagram of the acceleration sensor.

### DETAILED DESCRIPTION

The provision of a separate hardware path that only enables output stages in control systems of restraint systems when valid sensor signals are present and the function of the processor has been verified by watchdogs has already been described. For minimal systems having only, for example, front airbags and belt tighteners, these functions may be integrated in the acceleration sensor itself, specifically in the logic component of the acceleration sensor. This implements a cost-effective restraint system, which is simultaneously very reliable. The validity of the sensor data is achieved through a simple threshold value comparison using, for example, a comparator. The watchdog function is achieved through watchdog timers that must be operated regularly by the processor.

In the present invention as described here, a central sensor in the control unit has a logic component that sets the behavior of lines for enabling the output stages. This makes it possible to omit a separate evaluation of the sensor signals on a particular component and accordingly save considerable expense.

Customarily, a micromechanical sensor element, a finger structure for example, is deflected by an acceleration. This deflection is measured by a capacitive method and is then digitized in an analog/digital converter. In addition, the sensor contains a logic component that interprets the instructions of a processor, preferably a microcontroller, and controls the internal sequences in the acceleration sensor. For example, sending the ReadData instruction via the acceleration sensor makes the acceleration data available. The data packets are customarily 16 bits wide and contain the following information:

| | |
|---|---|
| 10 | bits of sensor data |
| 3 | bit identifier for the sensor type |
| 1 | bit identifier for a current sensor test |
| 1 | bit identifier for a successful programming of the sensor |
| 1 | bit identifier for an inaccurate SPI (serial peripheral |
| | interface) transmission. |

The logic component is now expanded to include a threshold value comparator and two watchdog timers in order to integrate the functions for checking the validity of the sensor signals and the function of the processor in the acceleration sensor.

Each time the sensor data is read, the result is compared with a threshold value. Only one fixed threshold value is possible because only one fixed sensor is now involved. If this sensor is able to sense in different directions or if a plurality of sensor elements is present, correspondingly more threshold values are then necessary. If the sensor data exceeds a symmetrical threshold, a retriggerable monoflop sets the line to the high side, i.e., the positive output stage for a certain time to enable. The values for the threshold as well as the enable time are predetermined through tests.

The line to the negative output stage is connected directly to a sensor test bit. When a sensor test is carried out, the sensor sends test data that exceeds the enable threshold. At the same time, a test bit (TEST) is set and accordingly the line to the negative output stage as well. In the following, the negative output stage is denoted as DIS_ALP while the line to the positive output stage is denoted as DIS_AHP.

Two watchdog timers use the internal sensor frequency as a time base. Instead of a separate instruction for binding the timers, this may also occur automatically. On the real-time level, for example, the ReadData instruction is used to operate the fast timer and the read ASIC ID instruction is used in the slow background level.

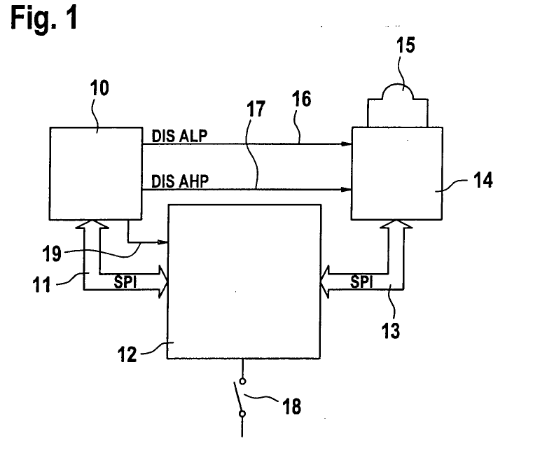

FIG. 1 shows a block diagram of the design of a control unit for activating restraining means using the sensor of the present invention. Acceleration sensor 10 is connected to a microcontroller 12 via a bidirectional line 11, the serial peripheral interface in this case. Serial peripheral interface 11 has a plurality of lines, one line being provided for the data transport from sensor 10 to microcontroller 12 and another line being provided for the data transport from microcontroller 12 to sensor 10. Additional lines of the SPI interface include the chip-select line, i.e., the selection or activation of modules, and the clock pulse. Acceleration sensor 10 may have a plurality of sensing elements in different spatial directions. Via SPI line 11, sensor 10 transfers the measured sensor data to microcontroller 12, which calculates an algorithm as a function of this sensor data, restraining means being activated as a function of the result of this algorithm. To that end, microcontroller 12 is connected to a trigger circuit control 14, denoted here as FLIC, via another SPI line 13. A firing instruction, for example, is transmitted via SPI line 13. Microcontroller 12 and accordingly the control unit are switched on via switch 18. This is the symbolic representation of the ignition key. Sensor 10 is connected to FLIC 14 via an output line 16, denoted as DIS_ALP. Via a second line, sensor 10 is reconnected with FLIC 14. Line 16 is used to enable the negative output stage while line 17 is used to enable the positive output stage. Symbolically, a triggering element 15 is shown on FLIC 14, which in the triggering case receives a high ignition current to produce a pyrotechnic response which triggers the airbag or belt tightener.

Sensor 10 carries out the watchdog functions described above via SPI line 11, i.e., microcontroller 12 must operate the watchdog timers of sensor 10 via line 11. If this does not occur, sensor 10, for example, resets microcontroller 12 via its watchdog timer and line 19 and simultaneously blocks the output stages via lines 16 and 17, making it impossible for processor 12 to execute an uncontrolled triggering of triggering elements 15. A first watchdog timer must be activated every one hundred milliseconds, which is intended for the background level of the operating system, while a watchdog timer in sensor 10 must be activated every millisecond for the real-time level of the operating system. Furthermore, sensor 10 initiates a self-test at the time it is switched on via switch 18. As a function of this self-test, the output stages in trigger circuit electronics 14 are also enabled via lines 16 and 17.

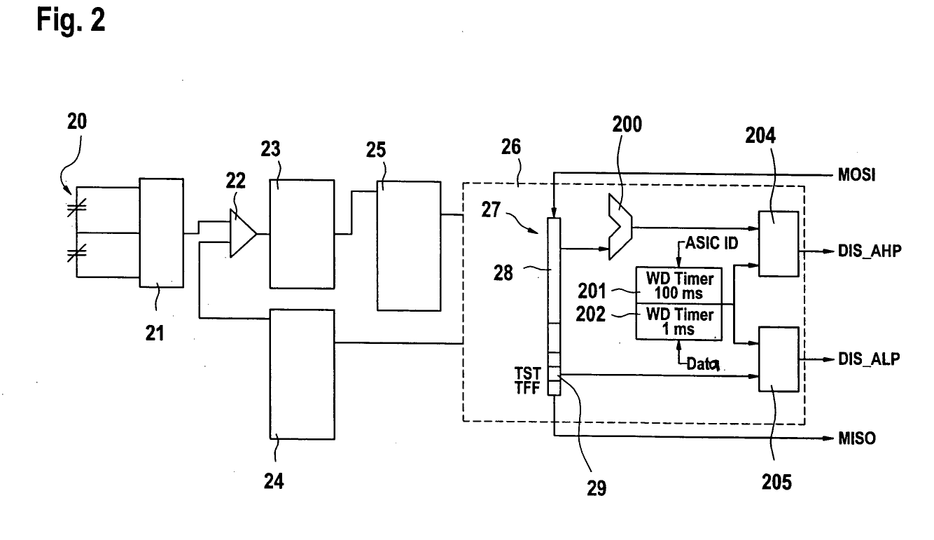

The design of the acceleration sensor according to the present invention is shown in FIG. 2. Micromechanical sensor elements 20 produce a capacitive measurement of accelerations occurring. This means that the capacitance of micromechanical elements 20 changes as a function of an occurring acceleration. A CU converter 21 converts this capacitance change into an analog voltage. Downstream from an amplifier 22, the signal is handed off to a low pass filter 23, whose output signal is supplied to an analog/digital converter 25. The digitized signal is then supplied to logic component 26 for further processing. In order to compensate for an offset measured automatically after the sensor is switched on, a digital/analog converter 24 is present, which is supplied digitally by logic component 26 and emits a corresponding output voltage which is provided to comparator 22. This eliminates the offset of the measured signal.

An instruction decoder and the sequence control are contained in logic component 26. Communication with processor 12 is via the 16 bit wide SPI interface. The data format is fixed and is broken down as follows:

| | |
|---|---|
| 10 | bits of sensor data |
| 3 | bit sensor identifier |
| 1 | bit for the display that the module has still not received |
| | the “end of programming” instruction |
| 1 | bit for the display of the sensor test denoted as TST and |
| 1 | bit denoted as TFF for displaying the SPI status. |

Frame 27 shows this data, the sensor data being denoted as 28 and the TST bit as 29. In logic component 26, sensor data 27 is supplied to a comparator 200. In comparator 200, it is compared with a predetermined threshold value, a value of 2.8 G in this case, to determine if the sensor data is valid. If the data is valid, it is supplied to module 204. This module 204 contains a monoflop, which sets an enable and thus line DIS_AHP for a specific time if the sensor data exceeds the threshold. This time may be, for example, 32 milliseconds. The enable times can be extended by transmitting an SPI instruction. Sensor test bit 29 is connected to another monoflop 205, which supplies a signal to line DIS_ALP. During the sensor test, line DIS_ALP is set to block while line DIS_AHP is set to enable by the sensor test data. This strategy makes it possible to test the positive and negative output stage independently of one another. The sensor test data is transferred from processor 12 to sensor 10 while the measuring data is transferred to processor 12 via line MISO. Watchdog timers 201 and 202 are also provided in logic component 26. In the normal case, watchdog timer 201 is triggered every 100 milliseconds by processor 12 via the Read ASIC ID instruction while watchdog timer 202 is triggered every millisecond via the ReadData instruction.

If a watchdog error occurs in one of the two timers 201 or 202, a status line is set which sets both line DIS_AHP and line DIS_ALP to block. This is also the status after every power-on reset. If both watchdog timers are operated correctly, the internal status line is reset. For a time period of 1 second, for example, the monoflops have the enable signal on the lines; after that, they return to their normal condition, which is block for line DIS_AHP and enable for line DIS_ALP.

1-10. (canceled)

11. An acceleration sensor in a control unit for activating at least one occupant protection device comprising:
a logic component for transferring a signal characterizing an acceleration to a processor in the control unit, the logic component being configured for checking the signal, the logic component being connected to output stages in such a way that the output stages are enabled as a function of the check.

12. The acceleration sensor according to claim 11, wherein the logic component checks the signal for validity using at least one fixed threshold value.

13. The acceleration sensor according to claim 11, wherein the logic component is connected to at least one positive output stage via a first line and to at least one negative output stage via a second line for an independent enabling of the output stages.

14. The acceleration sensor according to claim 11, wherein the logic component is configured in such a way that the logic component enables the output stages for a predetermined time as a function of the check.

15. The acceleration sensor according to claim 11, wherein the acceleration sensor is configured in such a way that the acceleration sensor enables the output stages as a function of a self-test.

16. The acceleration sensor according to claim 11, wherein the logic component is additionally configured for testing the processor.

17. The acceleration sensor according to claim 16, wherein the logic component includes at least two watchdogs for the testing.

18. The acceleration sensor according to claim 17, wherein the at least two watchdogs include a first watchdog for testing a real-time level of an operating system of the processor and a second watchdog for testing a background level.

19. The acceleration sensor according to claim 18, wherein the first and second watchdogs each have a timer.

20. The acceleration sensor according to claim 11, further comprising a housing, the logic component being situated in the housing.
